(19) United States
(12) Patent Application Publication
(10) Pub. No.: US 2025/0050398 A1
(43) Pub. Date: Feb. 13, 2025

(54) APPARATUS FOR MANUFACTURING PRISMATIC CAN

(71) Applicant: SAMSUNG SDI CO., LTD., Yongin-si (KR)

(72) Inventor: Man Soo SHIN, Yongin-si (KR)

(21) Appl. No.: 18/600,455

(22) Filed: Mar. 8, 2024

(30) Foreign Application Priority Data
Aug. 10, 2023 (KR) 10-2023-0104640

(51) Int. Cl. B21C 26/00; B21C 23/18; B21C 25/02

(52) U.S. Cl. CPC B21C 26/00; B21C 23/183; B21C 25/02

(57) ABSTRACT

An apparatus for manufacturing a prismatic can includes a die configured to support a bar-shaped slug, a punch arranged on a horizontal axis of the die to reciprocate in a left and right direction so as to press the slug supported on the die, and a connecting rod between a driver configured to generate power and the punch to transmit the power generated by the driver to the punch. A cross-section of an edge of the punch in a direction of the die has a rectangular shape corresponding to a bottom surface of an impact can to be manufactured, and upper and lower areas of the punch are provided in an asymmetrical shape based on a horizontal axis center line.

### CROSS-REFERENCE TO RELATED APPLICATION

The present application claims priority to and the benefit of Korean Patent Application No. 10-2023-0104640, filed on Aug. 10, 2023 in the Korean Intellectual Property Office, the entire disclosure of which is incorporated herein by reference.

### BACKGROUND

### 1. Field

Aspects of embodiments relate to an apparatus for manufacturing a prismatic can.

### 2. Description of the Related Art

Batteries may be classified into prismatic batteries, cylindrical batteries, pouch-type batteries, and the like depending on their shape. Such a prismatic or cylindrical battery may be manufactured by inserting an electrode assembly including a positive electrode, a negative electrode, and a separator into a metal can and then sealing the metal can, and such a pouch-type battery may be manufactured by wrapping an electrode assembly with aluminum foil coated with an insulating material.

A method for manufacturing the battery can according to the related art may include a deep drawing method, an impact method, etc. In the deep drawing method, a sheet-shaped metal plate may be disposed on a molding die, and punching may be performed approximately ten times on the metal plate using a punch to complete the can. In the impact method, a billet-shaped slug may be disposed on a molding die, and a strong punching may be performed approximately one time on the slug using a punch to complete the can. This impact method may reduce the number of processes to reduce manufacturing costs of the can.

However, both the deep drawing method and the impact method according to the related art have limitations in reducing a thickness of the can due to characteristics of the manufacturing process, and there is a limitation of causing a large thickness variation depending on an area of the can.

The above-described information disclosed in the technology that serves as the background of the present disclosure is provided for improving understanding of the background of the present disclosure and, thus, may include information that does not constitute the related art.

### SUMMARY

According to an aspect of one or more embodiments of the present disclosure, an apparatus for manufacturing a prismatic can is provided, which is capable of manufacturing an impact prismatic can having a uniform (uniform or substantially uniform) sidewall thickness. According to aspects of one or more embodiments of the present disclosure, an apparatus for manufacturing a prismatic can is provided, in which rigidity of an impact mold punch is reinforced to minimize or reduce buckling in an impact method using a high-speed mechanical horizontal press, and the impact mold punch that is provided so as not to interfere with rotating logistics for inputting and dispensing a slug is adopted to improve product quality and product reliability.

According to some embodiments, an apparatus for manufacturing a prismatic can includes: a die configured to support a bar-shaped slug; a punch arranged on a horizontal axis of the die to reciprocate in a left and right direction so as to press the slug supported on the die; and a connecting rod between a driver configured to generate power and the punch to transmit the power generated by the driver to the punch, wherein a cross-section of an edge of the punch in a direction of the die has a rectangular shape corresponding to a bottom surface of an impact can to be manufactured, and upper and lower areas of the punch are provided in an asymmetrical shape based on a horizontal axis center line.

The upper area of the punch may be constituted by a first pressing area in the direction of the die and a first reinforcement area in a direction of the connecting rod, and the lower area of the punch may be constituted by a second pressing area in the direction of the die and a second reinforcement area in the direction of the connecting rod.

Based on a longitudinal direction of the punch, a length of the first pressing area may be less than that of the second pressing area.

Based on a longitudinal direction of the punch, a length of the first pressing area may correspond to a height of a side surface extending from the bottom surface of the impact can.

A thickness of each of the first pressing area and the second pressing area may correspond to a width of a short side of a side surface extending from the bottom surface of the impact can.

Based on a longitudinal direction of the punch, a width of the punch may correspond to a width of a long side of a side surface extending from the bottom surface of the impact can.

Each of the first pressing area and the second pressing area may have a thickness less than that of each of the first reinforcement area and the second reinforcement area.

The first pressing area and the first reinforcement area may be connected to each other to be inclined in a tapered shape, and the second pressing area and the second reinforcement area may be connected to each other to be inclined in a tapered shape.

The apparatus may further include a stripper between the die and the punch to pass through the punch if the punch reciprocates.

A cross-section of a portion of the punch, which is inserted in the stripper, at a position of a bottom dead center may be greater than that of the lower area.

A cross-section of a portion of the punch, which is inserted in the stripper, at a position of a bottom dead center may have a T shape.

The stripper may have a hole to correspond to the shape of the cross-section through which the punch passes.

The hole of the stripper may be inclined such that a size of the hole that is in contact with the punch is greater than that of the hole at an opposite side.

The apparatus may further include a transfer part between the die and the punch and configured such that the slug is on a horizontal axis of the die and the punch, and the impact can manufactured by the punch is withdrawn.

The transfer part may be provided with radial blades to rotate so as to transfer the slug and the impact can.

An area of a lower portion of the punch, which passes through the stripper, at a position of a bottom dead center may have a thickness corresponding to a gap between the blades so as not to interfere with the blades.

The apparatus may further include: a punch holder configured to fix the punch; a slide connected between the connecting rod and the punch holder to horizontally transmit power from the connecting rod; and a slide guide configured to support horizontal movement of the slide.

The punch holder may be mounted on the slide such that a slide-side load application point and a load center point of the punch are on a same horizontal extension line.

The punch holder may be mounted on the slide such that a slide-side load application point is vertically below a horizontal extension line of the connecting rod axis by an amount of eccentricity.

The amount of eccentricity may be calculated based on a distance between the horizontal extension line of the connecting rod axis and a horizontal extension line of a load center point of the punch, based on the slide-side load application point.

The amount of eccentricity may be in a range of about 5 mm to about 25 mm.

### BRIEF DESCRIPTION OF DRAWINGS

The accompanying drawings are included to provide a further understanding of the present disclosure, and are incorporated in and constitute a part of this specification. The drawings illustrate some example embodiments of the present disclosure and, together with the description, serve to explain principles of the present disclosure. In the drawings:

FIGS. 1A, 1B, and 1C illustrate a perspective view, a cross-sectional view showing a long side thickness, and a cross-sectional view showing a short side thickness of an impact can, respectively, according to one or more embodiments;

FIG. 2 illustrates a left side view, and FIGS. 3A and 3B illustrate perspective views, of an apparatus for manufacturing a prismatic can according to one or more embodiments;

FIGS. 4A and 4B illustrate perspective views of a punch and a punch buckling state according to the related art, and FIG. 4C illustrates perspective views of a punch and a punch buckling state according to one or more embodiments;

FIGS. 5A and 5B illustrate a perspective view of a coupling relationship between the punch and a stripper and a cross-sectional view of the punch at a coupling position, respectively, according to one or more embodiments;

FIGS. 6A and 6B illustrate left side views of a horizontal press structure according to the related art and a horizontal press structure according to one or more embodiments, respectively; and

FIG. 7 illustrates a relationship between an amount of eccentricity and an amount of punch lifting for each molding load of the apparatus for manufacturing the prismatic can according to one or more embodiments.

### DETAILED DESCRIPTION

While some example embodiments of the present disclosure are described herein to more completely explain the present disclosure to those skilled in the art, the following examples may be modified in various other forms. Embodiments of the present disclosure may, however, be embodied in many different forms and are not to be construed as being limited to the embodiments set forth herein; rather, these embodiments are provided so that those skilled in the art may thoroughly understand the present invention. Rather, these embodiments are provided so that this disclosure will be thorough and complete, and will fully convey the embodiments of the present disclosure to those skilled in the art.

In some embodiments, in the following drawings, the thickness or size of components or layers may exaggerated for convenience and clarity of description, and the same reference numerals in the drawings refer to the same elements. As used herein, the term “and/or” includes any and all combinations of one or more of the associated listed items. In this specification, it is also to be understood that if a member A is referred to as being connected to a member B, the member A may be directly connected to the member B or indirectly connected to the member B with one or more members C therebetween.

The terms used in this specification are for illustrative purposes of the present disclosure and should not be construed to limit the meaning or the scope of the present disclosure. As used in this specification, a singular form may, unless definitely indicating a particular case in terms of the context, include a plural form. Also, the expressions “comprise/include” and/or “comprising/including” used in this specification neither define the mentioned shapes, numbers, steps, operations, members, elements, and/or groups of these, nor exclude the presence or addition of one or more other different shapes, numbers, steps, operations, members, elements, and/or groups of these, or addition of these. The term “and/or” used herein includes any and all combinations of one or more of the associated listed items.

As used herein, terms such as “first,” “second,” etc. are used to describe various members, components, areas, layers, and/or portions. However, it is to be understood that the members, components, areas, layers, and/or portions should not be defined by these terms. The terms do not mean a particular order, up and down, or superiority, and are used for distinguishing one member, component, region, layer, or portion from another member, component, region, layer, or portion. Thus, a first member, component, region, layer, or portion which will be described may also refer to a second member, component, region, layer, or portion, without departing from the teaching of the present disclosure.

Spatially relative terms, such as “below,” “beneath,” “lower,” “above,” “upper,” and the like, may be used herein for ease of description to describe one element or feature's relationship to another element(s) or feature(s), referring to the figures. These spatially relative terms are intended for ease of comprehension of the present invention according to various process states or usage states of the present invention, and, thus, the present disclosure is not limited thereto. For example, if an element or feature shown in the drawings is turned, the element or feature described as “beneath” or “below” may change into “above” or “upper.” Thus, the term “lower” may encompass the term “upper” or “below.”

Unless otherwise defined, all terms (including technical and scientific terms) used herein have the same meaning as commonly understood by one of ordinary skill in the art to which the inventive concept pertains. It is also to be understood that terms defined in commonly used dictionaries should be interpreted as having meanings consistent with the meanings in the context of the related art, and are expressly defined herein unless they are interpreted in an ideal or overly formal sense.

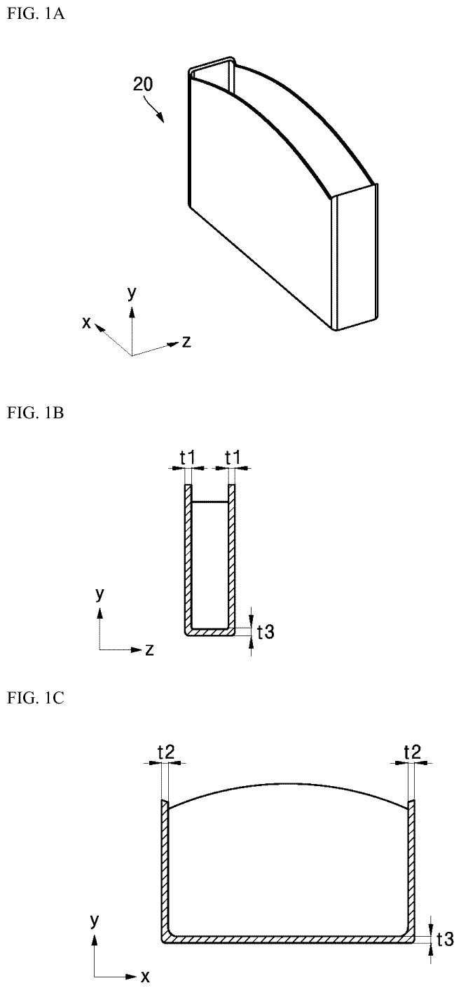

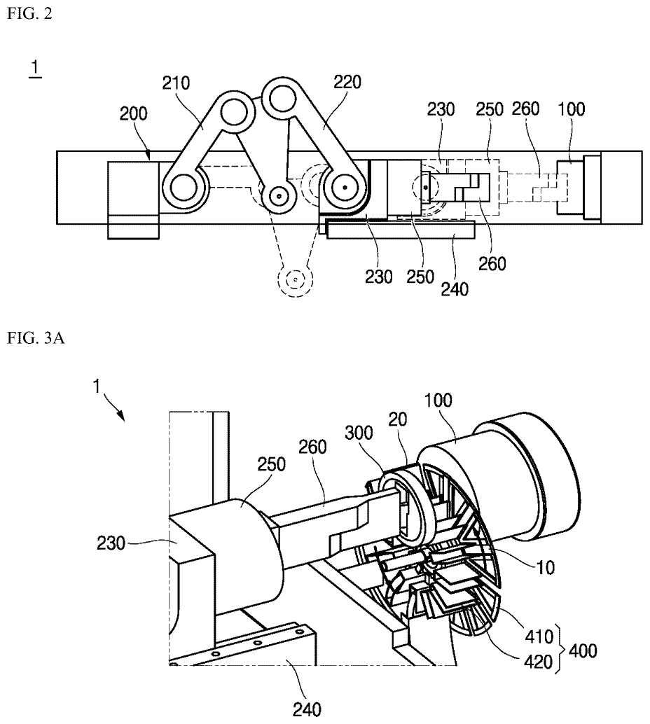

FIGS. 1A, 1B, and 1C illustrate a perspective view, a cross-sectional view showing a long side thickness, and a cross-sectional view showing a short side thickness of an impact can, respectively, according to one or more embodiments; and FIG. 2 illustrates a left side view, and FIGS. 3A and 3B illustrate perspective views, of an apparatus for manufacturing a prismatic can according to one or more embodiments.

In general, a method for manufacturing a prismatic battery can applied to electric vehicles, etc. may include a deep drawing method and an impact method. In the impact method, a billet-shaped slug may be disposed on a molding die, and a strong punching may be performed approximately one time on the slug using a punch to complete the can.

Embodiments relate to the impact method. To manufacture a prismatic can using the impact method, impact, ironing, cutting, cleaning, and inspection processes may be performed from a slug-shaped raw material. In some embodiments, the impact process may be classified into a main pre-processing process, an ironing process (and opening correction) as a pre-processing process, and cutting/cleaning/inspection processes such as remaining post-processes. In some embodiments, in the impact process, a molded product manufactured by impacting a slug and extruding the slug in a forward direction may be called an impact preform, and a final can may be completed through the post-processing process and the post-processes from the impact preform. Herein, for convenience of explanation, the impact preform will be collectively referred to as an impact can.

In the impact process, approximately one strong punching may be applied to the slug by a mold punch to generate the impact can, and, thus, there may be higher possibility of a non-uniform pattern in sidewall thickness compared to the deep drawing method. In some embodiments in which non-uniformity occurs in a thickness of the sidewall of the can, a long side may have a random difference in thickness between a front surface and a rear surface, and the thickness of the sidewall of the can may become thinner or thicker from an upper portion (inlet) to a lower portion (bottom) of the can. Similar to the long side, one of the short sides may become thinner from the upper portion to the lower portion of the can, and the other of the short sides may have an opposite thickness pattern. In some embodiments of the short side, unlike the long side, a biased direction of the thickness may not be random, but may be constant.

Even after performing the post-processing process (e.g., ironing), the thickness non-uniformity determined in the impact process may not be corrected, and an outer appearance of the can may be defective (e.g., \textcircled{1} crack/rupture at a center of the long side, \textcircled{2} crack/rupture at a center of the long side, \textcircled{3} elongation/rupture at a corner of a lower portion of the long side, \textcircled{4} concavity/convexity of the long side, and \textcircled{5} slit of the short side). In some embodiments, the sidewall structure and thickness characteristics of the final prismatic can may be determined in the impact process.

In some embodiments, an impact process of molding an impact can 20 from a slug 10 and extruding the molded impact can 20 in a forward direction through an apparatus 1 for manufacturing the prismatic can will be described. In some embodiments, referring to FIG. 1, the impact can 20 having an opening defined in a side thereof, a rectangular bottom part, and a sidewall extending in a height direction (y-axis direction in FIG. 1A) from the bottom part may be manufactured. In some embodiments, referring to FIGS. 1B and 1C, in the sidewall, an x-axis direction may be referred to as a long side, and a z-axis direction may be referred to as a short side. Based on the long side, the long side may be constituted by a front surface and a rear surface, and the short side may be constituted by a left surface and a right surface. In some embodiments, a thickness of the long side (sidewall thickness) may be expressed as t1, a thickness of the short side may be expressed as t2, and a thickness of the bottom surface may be expressed as t3. The slug 10 may be used as a material of the can to be molded and, for example, may include aluminum, an aluminum alloy, steel, a steel alloy, or equivalents thereof, but the material is not limited thereto.

Referring to FIG. 2, the apparatus 1 for manufacturing the prismatic can according to some embodiments of the present disclosure may include a die 100 supporting the bar-shaped slug 10 and a punch 260 that presses the slug 10 supported on the die 100. In some embodiments, the punch 260 may be disposed on a horizontal axis of the die 100 to reciprocate in a left and right direction by power from a driver 200. In some embodiments, the apparatus 1 for manufacturing the prismatic can may include a connecting rod 220 that is disposed between the driver 200 and the punch 260 to transmit the power from the driver 200 to the punch 260. The connecting rod 220 may change rotational movement of a crankshaft 210 connected to the driver 200 into linear movement of the punch 260.

In some embodiments, the apparatus 1 for manufacturing the prismatic can may include a punch holder 250 that fixes the punch 260, a slide 230 that is connected between the connecting rod 220 and the punch holder 250 to transmit power from the connecting rod 220 in the horizontal direction, and a slide guide 240 that supports the horizontal movement of the slide 230.

In some embodiments, the apparatus 1 for manufacturing the prismatic can may drive the crankshaft 210 to rotate by the driver 200 and may horizontally reciprocate the slide 230 by the rotation of the crankshaft 210. In some embodiments, force due to the reciprocating movement may be transmitted to the punch 260 mounted on the punch holder 250 connected to the slide 230. In some embodiments, the driver 200 may include a motor, a driver for driving the motor, a controller, and the like. However, the controller is not limited thereto and may be provided separately.

A solid line in FIG. 2 may illustrate motion near a top dead center at which the punch 260 moves to a left side (toward the driver), and a rotation angle of the crankshaft 210 is about 0°, and a dotted line may illustrate motion of a bottom dead center at which the punch 260 moves to a right side (toward the die), and a rotation angle of the crankshaft 210 is about 360°. In some embodiments, the solid line may be referred to as an ascending state of the slide 230, and the dotted line may be referred to as a descending state of the slide 230. In some embodiments, the rotational force may be converted into linear force through crank motion of the crankshaft 210, and a cycle in which the rotation angle is changed in a range of about 0° to about 360° in a unit stroke may be continuously repeated.

In some embodiments, the apparatus 1 for manufacturing the prismatic can may be a high-speed mechanical horizontal press. The driver 200 of the apparatus 1 for manufacturing the prismatic can may operate at a high speed of, for example, about 60 strokes per minute (spm) or more.

FIG. 3A illustrates a perspective view when the rotation angle of the crankshaft 210 is any one of about 0° to 180°, and FIG. 3B illustrates a perspective view when the rotation angle of the crankshaft 210 is about 360 degrees°. In some embodiments, referring to FIG. 3A, when the punch 260 is disposed near the top dead center, a transfer part 400 may rotate to dispose the slug 10 at a pressing position of the punch 260. In some embodiments, referring to FIG. 3B, when the punch 260 is disposed at the position of the bottom dead center, and the punch 260 presses the slug 10, referring to FIG. 3A, the extruded impact can 20 may rotate to be transferred.

In some embodiments, referring to FIGS. 3A and 3B, in the apparatus 1 for manufacturing the prismatic can, the punch 260 may pass through a stripper 300 when the punch 250 reciprocates, and the punch 260 and the stripper 300 may be configured so as not to interfere with the transfer part 400. The stripper 300 may be disposed between the punch 260 and the transfer part 400 such that interference with the transfer part 400 is avoided when the punch 260 reciprocates.

The stripper 300 may be disposed between the die 100 and the punch 260 to pass through the punch 260 when the punch 260 reciprocates. In some embodiments, the stripper 300 may have a hole defined to correspond to a shape of a cross-section through which the punch 260 passes. A further detailed description of the stripper 300 will be provided later.

In some embodiments, the transfer part 400 may be disposed between the die 100 and the punch 260, the slug 10 may be disposed on a horizontal axis of the die 100 and the punch 260 to withdraw the impact can 20 manufactured by the punch 260. In some embodiments, the transfer part 400 may include a slug transfer part 410 having radial blades to rotate such that the slug 10 is input/transferred, and a can transfer part 420 that transfers the impact can 20. In some embodiments, the slug transfer part 410 and the can transfer part 420 may have radial blades disposed at corresponding positions. In some embodiments, when the slug 10 input/transferred by the slug transfer part 410 is extruded by the punch 260, the slug 10 may be disposed on the corresponding can transfer part 420 to rotate and then be transferred to a portion at which the impact can 20 is discharged.

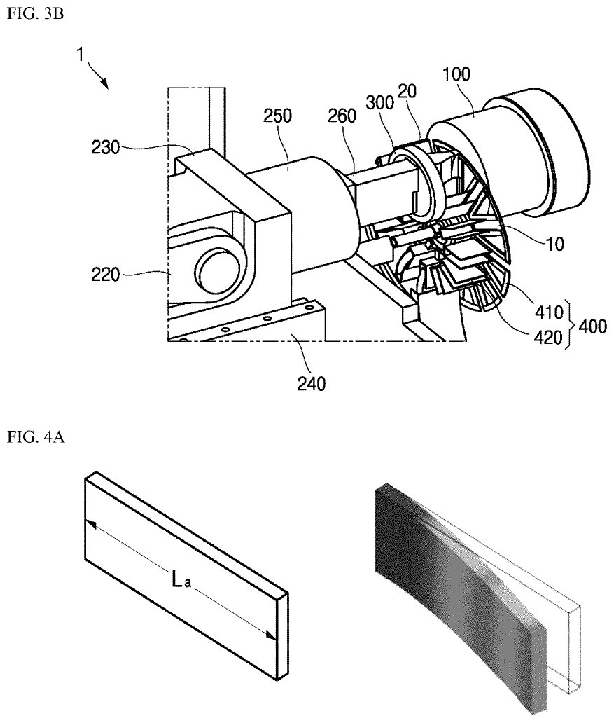

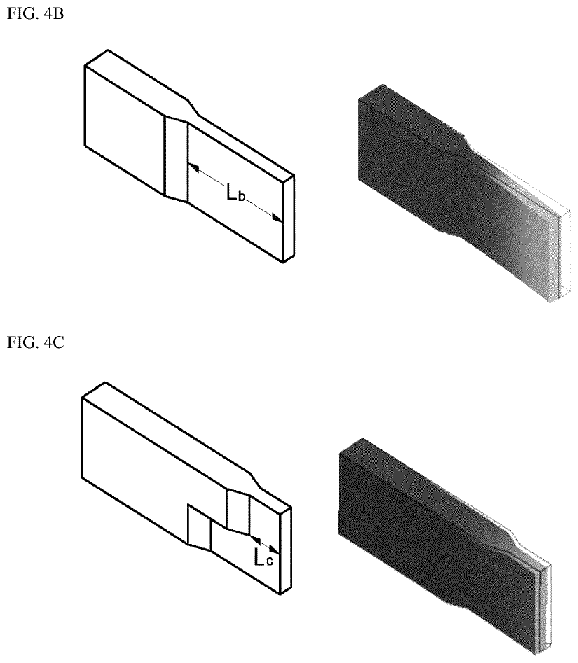

FIGS. 4A and 4B illustrate perspective views of a punch and a punch buckling state according to the related art, and FIG. 4C illustrates perspective views of a punch and a punch buckling state according to one or more embodiments. FIGS. 5A and 5B illustrate a perspective view of a coupling relationship between the punch and the stripper, and a cross-sectional view of the punch at a coupling position, respectively, according to various embodiments.

In the impact method, the thickness t1 of the long side and the thickness t2 of the short side may be completed through an interaction between a punch-die clearance, which is a gap between the punch 260 and the die 100, and the lubricated slug 10. If a limitation in thickness occurs, for example, the thickness t1 of the long side may be randomly biased toward the front/rear surfaces due to buckling of the punch 260. In some embodiments, the thickness t2 of the sidewall may become thinner as it goes downward to the bottom due to a direction in which the punch is bent, and a height of the sidewall may be further developed compared to an opposite side. In some embodiments, if the biasing is extreme, cracks or rupture may occur at the side, at which the height of the sidewall is excessively developed, to interfere with the transfer part 400 and cause an emergency stop of the apparatus 1 for manufacturing the prismatic can. If the apparatus 1 for manufacturing the prismatic can is stopped, damage of components may occur, and resulting in loss of production time due to spare replacement and mold preheating.

In an impact can in which each of the long and short sides has a non-uniform thickness according to the related art, various appearance defects (slits, waves, convexities/concavities, cracks, fractures, etc.) may occur in a post-processing (e.g., ironing) process. The ironing may be a process in which an outer wall of the aluminum can is skimmed upward to increase in height and decrease in thickness. If the ironing occurs concurrently (e.g., simultaneously) on the long side, the short side, and the corners at which the long side and the short side meet each other, uniform height variation may be essential over an entire circumference of each surface of the can and connection corner therebetween, and if a balance is poor due to a change in height, the above-mentioned appearance defects may occur depending on the location and degree. For example, if the corner at which the very thick long side and the short side thinner than the mold clearance meet each other, the thick long side may have a large height change, and the thin short side may have no height change, and, thus, strong shear stress may be developed around the corner to cause tearing (e.g., rupture). The defects in appearance and rupture are sorted as defective in the inspection process and be reflected to a good quality ratio. In some embodiments, there is possibility that a weak thickness portion, which is not visible from the outside, may occur in the ironing process. If the defects occur frequently under specific manufacturing conditions (mold setting, date, and shift) and lead to leakage defects, safety-related issues may arise if the finished battery is applied.

Referring to FIG. 4A, because the impact mold punch according to the related art extrudes the prismatic can, the impact mold punch may be based on a thin structure in which a cross-section of the bottom of the can simply extends (Lₐ) in a height direction. In some embodiments, a component of force may be generated in a lateral (front/rear direction of the long side) of a vertical load during the impact according to the shape, position, and lubricated state of the slug to cause buckling of the punch. As an example, the lateral force of only 0.05% of the vertical load may cause buckling beyond the punch-die clearance (see right view in FIG. 4A). A thickness of the surface facing the buckling may become thinner than the opposite side and may become even thinner as it goes downward toward the bottom. The thinner long side may have a development height greater than that of the opposite long side, and, if this height is excessive, the cracks or tears may occur starting from a center of an upper portion thereof.

The buckling of the punch, which is the cause of the non-uniform thickness of the long side, may be improved by reinforcing rigidity of the punch. In the related art, referring to FIG. 4B, the thickness of the punch increased from the bottom dead center to a certain area (Lₐ-L_{b}) to avoid the interference, thereby reinforcing the rigidity. This simple reinforcement may significantly improve the rigidity compared to the basic punch (see FIG. 4A), but dimensional and molding defects may still occur at any time, and, thus, the rupture of the long side may occur occasionally, and the press stop may occur (see right view in FIG. 4B). This may implicate that there is possibility of repeated facility shutdown at a level at which an operation is difficult according to the mold setting conditions.

In some embodiments of the present disclosure, referring to FIG. 4C, a structure that reinforces the rigidity of the punch 260 and avoids the interference may be provided. In some embodiments, referring to FIG. 5A, the stripper 300 may be disposed between the punch 360 and the transfer part 400 to avoid the interference with the transfer part 400 by the punch 260. A hole defined in the stripper 300 may be defined to correspond to the structure of the punch 260.

The punch 260 according to some embodiments may enlarge the reinforcement area compared to the reinforcement structure (see FIG. 4B) according to the related art and may have a structure in which the reinforcement area is further enlarged on the remaining area of the upper portion of the punch 260 except for L_{c} based on a horizontal virtual line. In some embodiments, a cross-section of the right side at the portion extending from the thin area of the lower portion of the punch to the reinforcement area may have a T shape (a T shape or a shape that is similar to a T shape) (see FIG. 5B). In some embodiments, the shape may be applied to the stripper 300 so as not to interfere with the transfer part 400 for inputting the slug and dispensing the can.

It is seen that the above structure may be applied to improve the buckling rigidity compared to the related art, referring to the right view in FIG. 4C. In some embodiments, the buckling rigidity may be improved by about 8.3 times compared to the basic type according to the related art (see FIG. 4A) and may be improved twice compared to the reinforced type (see FIG. 4B). In some embodiments, an improvement in process capability of Cₚ 1.33 (4σ) or more may be expected. In some embodiments, if the punch structure according to some embodiments is applied, the possibility of the dimensional defects exceeding a dimensional tolerance may be improved from a level of Sigma 3.0 (i.e., defect rate of about 2,700 parts per million (ppm)) to a level of Sigma 4.0 (i.e., defect rate of about 63 ppm). In some embodiments, the molding defects and the press stop limitation caused by the excessive biasing may be almost eliminated.

More specific structures of the punch 260 and stripper 300 according to some embodiments will be described later.

Referring to FIG. 5A, the punch 260 may be divided into an upper area 261 and a lower area 262 based on a horizontal virtual center line (x-axis in FIG. 5A), and the upper area 261 and the lower area 262 may be defined in an asymmetric shape. A cross-section of an edge of the punch 260 in the direction of the die 100 may be provided in a rectangular shape corresponding to the bottom surface of the impact can 20 to be manufactured.

In some embodiments, the upper area 261 of the punch 260 may be constituted by a first pressing area 261a in the direction of the die 100 and a first reinforcement area 261b in the direction of the connecting rod 220. In some embodiments, the lower area 262 of the punch 260 may be constituted by a second pressing area 262a in the direction of the die 100 and a second reinforcement area 262b in the direction of the connecting rod 220.

In some embodiments, the first pressing area 261a may be thinner than the first reinforcement area 261b. In some embodiments, the second pressing area 262a may be thinner than the second reinforcement area 262b.

In some embodiments, a length of the first pressing area 261a may be shorter than that of the second pressing area 262a, based on a longitudinal direction (x-axis direction) of the punch 260. In some embodiments, the length of the first pressing area 261a may correspond to a height of the side surface extending from the bottom surface of the impact can 20 (length in the y-axis direction in FIG. 1), based on the longitudinal direction of the punch 260. In some embodiments, the impact can 20 may be provided to have a height corresponding to the length of the first pressing area 261a.

In some embodiments, a thickness (length in the z-axis direction in FIG. 5A) of each of the first pressing area 261a and the second pressing area 262a may correspond to a width (length in the z-axis direction in FIG. 1) of the short side of the side surfaces extending from the bottom surface of the impact can 20. In some embodiments, a width (length in the y-axis direction in FIG. 5A) of the punch 260 may correspond to a width (length in the x-axis direction in FIG. 1) of the long side of the side surfaces extending from the bottom surface of the impact can 20.

In some embodiments, referring to FIG. 5A, in a cross-section (surface taken along the line A-A′ based on the y-axis in FIG. 5A) of a portion of the punch 260, which is inserted into the stripper 300, at the position of the bottom dead center of the punch 260, the upper area 261 may have a thickness greater than that of the lower area 262. In some embodiments, referring to FIG. 5B, the cross-section of the portion of the punch 260, which is inserted into the stripper 300, at the bottom dead center may be provided in a T shape.

In some embodiments, each of the first pressing area 261a and the first reinforcement area 261b may be connected to be inclined in a tapered shape. In some embodiments, each of the second pressing area 262a and the second reinforcement area 262b may also be connected to be inclined in a tapered shape. In some embodiments, the limitations of preventing or substantially preventing damage and distributing stress concentration may be solved, and natural matching with the stripper 300 may be achieved.

In some embodiments, the stripper 300 may have a hole defined to correspond to a shape of the cross-section through which the punch 260 passes. In some embodiments, the hole of the stripper 300 may also be provided in a T shape. In some embodiments, because the first and second pressing areas 261a and 262a of the punch 260 and the first and second reinforcement areas 261b and 262b are connected to be inclined, the hole of the stripper 300 may also be defined to be inclined. In some embodiments, the hole of the stripper 300 may be defined to be inclined such that a size of the hole in a surface (rear surface 300b in FIG. 5A) that is in contact with the punch 260 is larger than that of the hole in an opposite surface (front surface 300a in FIG. 5A).

In some embodiments, the area passing through the stripper 300 on the lower area 262 of the punch 260 at the position of the bottom dead center of the punch 260 may be provided so as not to interfere with the blades of the transfer part 400. In some embodiments, a thickness (length in the z-axis direction in FIG. 5A) of the area passing through the stripper 300 on the lower area 262 of the punch 260 at the position of the bottom dead center of the punch 260 may correspond to a gap between the blades. In some embodiments, the reinforcement areas of the upper area 261 and the lower area 262 may not be provided to be the same, but the reinforcement area of the lower area 262 may be provided in a smaller asymmetrical shape such that the punch 260 does not interfere with the transfer part 400 during reciprocation of the punch 260.

In some embodiments, as described above, each of the holes of the punch 260 and the stripper 300 may be defined in the T shape to minimize or reduce buckling of the punch 260 such that the thickness t1 of the long side of the impact can 20 is uniform. For example, according to the related art, a median value was around ±11%, and a Cₚ value was around 1.0, and, thus, there was high possibility of defects due to falling short of a required tolerance. In some embodiments, a thickness of a surface to which the punch is buckled to approach may be thinner than that of the other side and may become thinner from the upper portion to the lower portion (bottom side) of the can. In some embodiments, the non-uniform thickness of the long side may cause frequent dimensional defects with an error of about ±0.02 in the clearance setting of the mold punch and the die, and the facility stopping may frequently occur due to poor impact molding by the excessive buckling of the punch. However, in some embodiments, the median value of about ±5% or less and the Cₚ value of about 1.33 or more may secured to reduce mold setting sensitivity, stabilize the dimensions, and prevent or substantially prevent the facility stopping due to the impact molding defects.

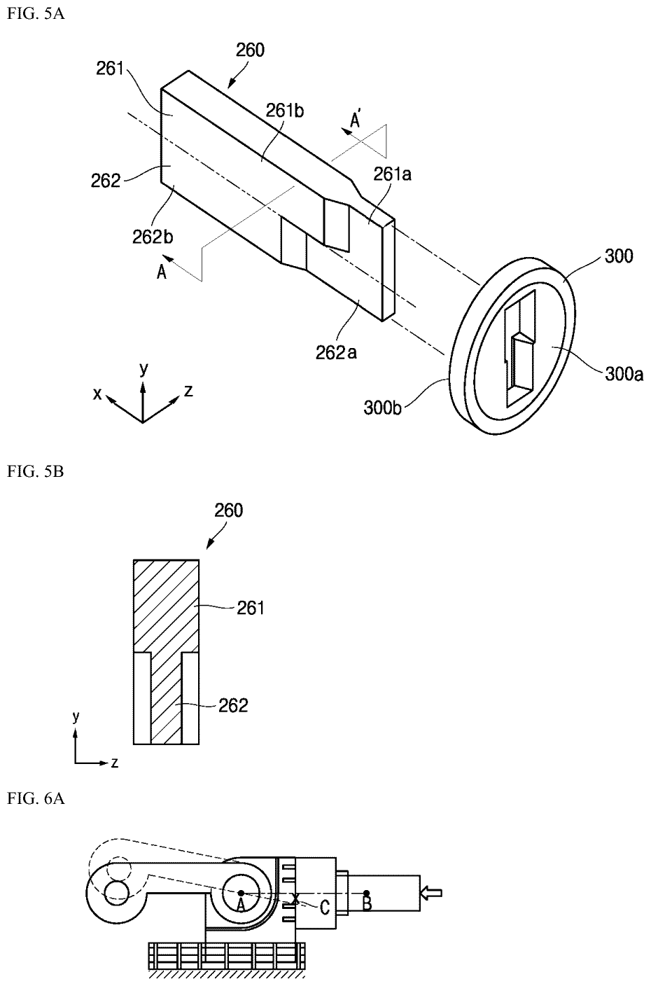

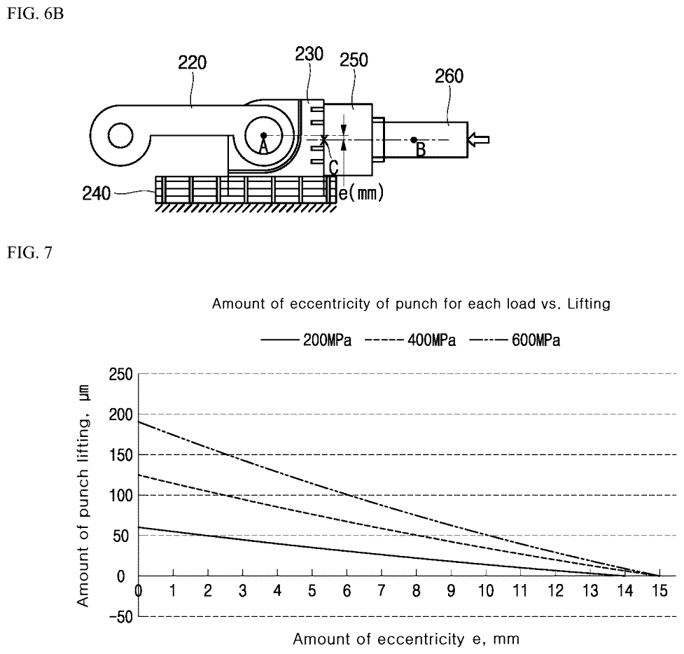

FIGS. 6A and 6B illustrate left side views of a horizontal press structure according to the related art and a horizontal press structure according to one or more embodiments, respectively; and FIG. 7 illustrates a relationship between an amount of eccentricity and an amount of punch lifting for each molding load of the apparatus for manufacturing the prismatic can according to one or more embodiments.

The apparatus 1 for manufacturing the prismatic can according to some embodiments may be a high-speed mechanical horizontal press having cost-competitive by maximizing a production rate (e.g., about 200 tonf to about 400 tonf, and about 90±30 spm or more), and in some embodiments, the apparatus 1 for manufacturing the prismatic can may use \textcircled{a} a mechanical press method, include a slide having \textcircled{b} a minimum or reduced size/weight (minimizing or reducing inertia), and \textcircled{c} a horizontal structure (efficiency of input/dispensing logistics).

The apparatus 1 for manufacturing the prismatic can according to some embodiments may restrict only two corners of the four corners of the slide 230. In some embodiments, because the two corners are in a free state, displacement may be allowed at the two corners in the free state when there is torque unbalance based on a load application point. The related components based on the load application point may include a connecting rod 220, a slide guide 240, a slide 230, a punch holder 250, and a punch 260. In some embodiments, force of the press may be transmitted to the slide 230 through the connecting rod 220 and may be balanced with molding reaction force through the punch 260. Referring to FIG. 6A, the horizontal press according to the related art may be provided to design a connection portion between the slide and the punch holder so that a horizontal extension line of a connecting rod axis A and an extension line of a load center point B of the punch coincide with each other.

The mechanical press may convert rotational force into linear force through crank motion and may continuously repeat a cycle, in which a rotation angle is changed from about 0° to about 360°, in a unit stroke. In some embodiments, a section in which actual molding force occurs may be the last section of the bottom dead center at an angle of about 350° to about 360°. The connecting rod may transmit the press force at an angle of about 350° to about 360° in an inclined state (not parallel to the punch), and, thus, a load application point C, which is a point of application of the molding force on the slide, may not be disposed on the horizontal extension line of the connecting rod axis A and the load center point B of the punch, but be disposed several millimeters to tens of millimeters below these extension lines (see FIG. 6A).

As a result, in the method according to the related art, which is illustrated in FIG. 6A, the slide at the time of impact may appear as a phenomenon in which a punch holder mounting surface rotates due to torque imbalance, and, thus, a front side of the punch in which the molding occurs is lifted. For example, when impacting an electric vehicle (load of about 250 tons), thickness non-uniformity of about A0.12 mm may occur in the vertical thickness t2 of the short side.

In some embodiments, referring to FIG. 6B, the load center point B of the punch 260 may be disposed on the same horizontal extension line as the load application point C of the slide 230. In some embodiments, the load application point C may move vertically downward by an eccentric distance e (mm) from the horizontal extension line of the connecting rod axis A, and, thus, the load application point C and the load center point B may be designed to be disposed on the same horizontal extension line. In some embodiments, the punch lifting may be eliminated. In some embodiments, referring to FIG. 7, it is seen that a load converges to a specific eccentricity value (˜about 15 mm) regardless of a load size. In some embodiments, an appropriate amount of eccentricity that ensures the torque balance may mainly depend on the design of the slide 230 and the punch holder 250 and may be relatively regardless of the load size.

In some embodiments, the punch holder 250 may be mounted on the slide 230 such that the load application point C of the slide 230 and the load center point B of the punch 260 are disposed on the same horizontal extension line. In some embodiments, the punch holder 250 may be mounted on the slide 230 such that the load application point C of the slide 230 is disposed vertically below the horizontal extension line of the connecting rod axis A by the amount of eccentricity. In some embodiments, the amount of eccentricity may be calculated based on a distance between the horizontal extension line of the connecting rod axis A and the horizontal extension line of the load center point B of the punch 260, based on the load application point C of the slide 230. For example, the amount of eccentricity may be about 5 mm to about 25 mm.

As described above, the load center point B of the punch 260 may be disposed on the same horizontal extension line as the load application point C of the slide 230, and, thus, the thickness t2 of the short side of the impact can 20 may be uniform. However, if the punch lifting phenomenon occurs as in the related art, there may be a high possibility of defects falling short of the required tolerance, for example, the median value is around about +9%, the Cₚ value has a level of about 1.0. A thickness of a surface that approaches when the punch is lifted may gradually become thinner from the upper portion to the lower portion (bottom) of the can. In some embodiments, in the non-uniform thickness of the short side, if the mold setting is defective in combination with the non-uniform thickness of the long side, defects of the outer appearance may occur frequently during the post-ironing process, and, in a worst case, leakage defects (through the inspection process) may occur in a state of hiding an excessive stretching thin film portion somewhere on the top/bottom/corner inside the can.

However, in some embodiments, as described above, the load center point B of the punch 260 may be disposed on the same horizontal extension line as the load application point C of the slide 230, and, thus, for example, the median value of about ±4% or more, and the Cₚ value of about 1.33 or more may be secured. In some embodiments, mold setting sensitivity may be reduced, the dimensions may be stabilized, the probability of appearance defects of the ironing may be reduced to about 4σ level, and the ironing may occur stably around a circumference of the can to prevent or substantially prevent local shear or stretching from occurring.

Because the non-uniformity of the bottom thickness t3 is dependent on the characteristics of the thickness t2 of the short side, if the uniformity of the short side may be improved, the bottom uniformity (especially in the left/right symmetry) may be significantly improved. Because the thickness non-uniformity of the short side has characteristics in which the biased direction is constant, unlike the long side, the shape of the bottom of the mold punch may be adjusted to solve the non-uniformity of the bottom thickness t3. In some embodiments, the shape of the bottom surface of the punch 260 in the direction of the die 100 according to some embodiments may be changed in response to the bottom thickness t3 of the impact can 20. For example, as the punch 260 is deformed upon the impact, a central thickness of the bottom may tend to be thicker than each of the left and right surfaces, and, thus, a curvature that compensates for this phenomenon may be applied to the shape of the bottom of the punch 260.

As described above, the apparatus 1 for manufacturing the prismatic can, to which the impact can method according to some embodiments is applied, may have a higher material utilization rate compared to the deep drawing method, and, also, the molding process may be reduced to three processes (\textcircled{1} impact-\textcircled{2} ironing-\textcircled{3} opening correction) compared to ten to fifteen processes of the deep drawing, such that the production speed per line has the potential to improve by more than four times. The cost competitiveness of the components may be proportional to Productivity×Good Product Rate. In some embodiments, it may be determined by a relationship Productivity=Production Speed×Operation Rate, and the Good Product Rate may include appearance quality related to the thickness. In some embodiments, as described above, the apparatus 1 for manufacturing the prismatic can according to embodiments may improve the cost competitiveness of the components by improving the limitations related to the productivity and yield.

According to embodiments of the present disclosure, the rigidity of the impact molding punch may be reinforced to minimize or reduce buckling in the impact method using the high-speed mechanical horizontal press, and the impact molding punch may be adopted so as not to interfere with the rotating logistics for inputting the slug and dispensing the can, and, thus, the thicknesses of the long side of the impact can and the sidewall of the short side may be uniform, and thickness patterns of the long/short sides may be removed or avoided to solve the issues of the productivity and the yield, which are seen in the mass production of the impact prismatic can for electric vehicle batteries according to the related art, thereby improving the product quality and the product reliability.

According to embodiments of the present disclosure, the impact method using the high-speed mechanical horizontal press may be applied to improve the impact speed and the overall line operation rate, thereby improving the production speed compared to the deep drawing prismatic can, and, also, the thickness quality and the yield, which have the equal or higher level, may be secured, and manufacturing costs and an installation area may be reduced.

According to embodiments of the present disclosure, the punch load center point may be disposed on the same horizontal extension line as the slide-side load application point based on the appropriate amount of eccentricity that ensures the torque balance to solve the limitation of the punch lifting phenomenon due to the torque imbalance at the impact, thereby improving the product quality such as the thickness of the short side of the prismatic can.

While some embodiments for carrying out the present disclosure have been described herein, the present disclosure is not limited to these embodiments, and it will be understood by a person skilled in the art that various changes in form and details may be made therein without departing from the spirit and scope of the present disclosure as set forth by the following claims.

What is claimed is:

1. An apparatus for manufacturing a prismatic can, the apparatus comprising:
a die configured to support a bar-shaped slug;
a punch arranged on a horizontal axis of the die to reciprocate in a left and right direction so as to press the slug supported on the die; and
a connecting rod between a driver configured to generate power and the punch to transmit the power generated by the driver to the punch,
wherein a cross-section of an edge of the punch in a direction of the die has a rectangular shape corresponding to a bottom surface of an impact can to be manufactured, and
upper and lower areas of the punch are provided in an asymmetrical shape based on a horizontal axis center line.

2. The apparatus as claimed in claim 1, wherein the upper area of the punch is constituted by a first pressing area in the direction of the die and a first reinforcement area in a direction of the connecting rod, and
the lower area of the punch is constituted by a second pressing area in the direction of the die and a second reinforcement area in the direction of the connecting rod.

3. The apparatus as claimed in claim 2, wherein, based on a longitudinal direction of the punch, a length of the first pressing area is less than that of the second pressing area.

4. The apparatus as claimed in claim 2, wherein, based on a longitudinal direction of the punch, a length of the first pressing area corresponds to a height of a side surface extending from the bottom surface of the impact can.

5. The apparatus as claimed in claim 2, wherein a thickness of each of the first pressing area and the second pressing area corresponds to a width of a short side of a side surface extending from the bottom surface of the impact can.

6. The apparatus as claimed in claim 2, wherein, based on a longitudinal direction of the punch, a width of the punch corresponds to a width of a long side of a side surface extending from the bottom surface of the impact can.

7. The apparatus as claimed in claim 2, wherein each of the first pressing area and the second pressing area has a thickness less than that of each of the first reinforcement area and the second reinforcement area.

8. The apparatus as claimed in claim 2, wherein the first pressing area and the first reinforcement area are connected to each other to be inclined in a tapered shape, and the second pressing area and the second reinforcement area are connected to each other to be inclined in a tapered shape.

9. The apparatus as claimed in claim 1, further comprising a stripper between the die and the punch to pass through the punch if the punch reciprocates.

10. The apparatus as claimed in claim 9, wherein a cross-section of a portion of the punch, which is inserted in the stripper, at a position of a bottom dead center is greater than that of the lower area.

11. The apparatus as claimed in claim 1, wherein the stripper has a hole to correspond to a shape of the cross-section through which the punch passes.

12. The apparatus as claimed in claim 11, wherein the hole of the stripper is inclined such that a size of the hole that is in contact with the punch is greater than that of the hole at an opposite side.

13. The apparatus as claimed in claim 1, further comprising a transfer part between the die and the punch and configured such that the slug is on a horizontal axis of the die and the punch, and the impact can manufactured by the punch is withdrawn.

14. The apparatus as claimed in claim 13, wherein the transfer part comprises radial blades to rotate so as to transfer the slug and the impact can.

15. The apparatus as claimed in claim 14, wherein an area of a lower portion of the punch, which passes through the stripper, at a position of a bottom dead center has a thickness corresponding to a gap between the blades so as not to interfere with the blades.

16. The apparatus as claimed in claim 1, further comprising:
a punch holder configured to fix the punch;
a slide connected between the connecting rod and the punch holder to horizontally transmit power from the connecting rod; and
a slide guide configured to support horizontal movement of the slide.

17. The apparatus as claimed in claim 16, wherein the punch holder is mounted on the slide such that a slide-side load application point and a load center point of the punch are on a same horizontal extension line.

18. The apparatus as claimed in claim 16, wherein the punch holder is mounted on the slide such that a slide-side load application point is vertically below a horizontal extension line of the connecting rod axis by an amount of eccentricity.

19. The apparatus as claimed in claim 18, wherein the amount of eccentricity is calculated based on a distance between the horizontal extension line of the connecting rod axis and a horizontal extension line of a load center point of the punch, based on the slide-side load application point.

20. The apparatus as claimed in claim 19, wherein the amount of eccentricity is in a range of about 5 mm to about 25 mm.
